(19) United States
(12) Patent Application Publication
(10) Pub. No.: US 2012/0176312 A1
(43) Pub. Date: Jul. 12, 2012

(54) POINTING DEVICE USING CAPACITIVE SENSING

(75) Inventor: YAN-MEI YANG, KAOHSIUNG CITY (TW)

(73) Assignee: HOWAY CORP., KAOHSIUNG CITY (TW)

(21) Appl. No.: 13/209,474

(22) Filed: Aug. 15, 2011

(30) Foreign Application Priority Data
Jan. 7, 2011 (TW) 100100656

(51) Int. Cl. G06F 3/033

(52) U.S. Cl. 345/158

(57) ABSTRACT

A pointing device includes: an operator supported above a substrate to be horizontally movable from an initial position; a conductive layer formed on the substrate and formed with conductive patterns spaced apart from each other to form a ring-shaped structure that is disposed coaxially around the operator when the operator is at the initial position; a conductor plate spaced apart from the conductive patterns, mounted coaxially on a bottom end of the operator, and having a diameter larger than an inner diameter of the ring-shaped structure; and a control unit providing a corresponding electrical signal to each conductive pattern during movement of the operator to measure a capacitance generated between each conductive pattern and the conductor plate so as to generate a sensing output corresponding to the measured capacitances, and generating a pointer signal corresponding to the movement of the operator based on the sensing output and predetermined capacitance information.

### CROSS-REFERENCE TO RELATED APPLICATION

This application claims priority to Taiwanese Application No. 100100656, filed on Jan. 7, 2011.

### BACKGROUND OF THE INVENTION

1. Field of the Invention

The invention relates to a pointing device, and more particularly to a pointing device using capacitive sensing.

2. Description of the Related Art

A conventional pointing stick includes an operating stick operable to control a vertical distance between a metal plate and each of a plurality of metallic electrodes disposed under the metal plate such that a capacitance between the metal plate and each metallic electrode can be determined based on a vertical distance therebetween. However, the conventional pointing stick may have a height that it too large to be suitable for electronic apparatuses with a compact size.

Another conventional pointing device utilizes magneto-electric transducers for detecting magnetic fields strengths of magnets to generate an analog voltage signal during movement of an operator. A processor can generate a pointer signal corresponding to the movement of the operator based on the analog voltage signal. However, such a conventional pointing device has a complicated structure and is fabricated at high cost.

Therefore, improvements may be made in the above techniques.

### SUMMARY OF THE INVENTION

Therefore, an object of the present invention is to provide a pointing device using capacitive sensing that can overcome the aforesaid drawbacks of the prior art.

According to one aspect of the present invention, there is provided a capacitive sensing device for sensing horizontal movement of an operator of a pointing device relative to an initial position. The capacitive sensing device comprises:

a substrate adapted to be disposed under the operator and having a top surface;

a conductive layer formed on the top surface of the substrate, and formed with a plurality of conductive patterns spaced apart from each other and configured to form a ring-shaped structure that is disposed coaxially around the operator when the operator is at the initial position;

a conductor plate adapted to be mounted coaxially on a bottom end of the operator such that the conductor plate is horizontally movable with the operator, and spaced vertically apart from the conductive patterns of the conductive layer, the conductor plate having a diameter larger than an inner diameter of the ring-shaped structure such that the conductor plate overlaps each of the conductive patterns when the operator is at the initial position; and

a capacitance sensor connected electrically to the conductive patterns, and providing a corresponding electrical signal to each of the conductive patterns to measure a capacitance generated between the conductor plate and each of the conductive patterns, the capacitances measured by the capacitance sensor being associated with the movement of the operator.

According to another aspect of the present invention, a pointing device comprises:

a substrate having a top surface;

an operator supported above the top surface of the substrate to be horizontally movable from an initial position;

a conductive layer formed on the top surface of the substrate, and formed with a plurality of conductive patterns spaced apart from each other and configured to form a ring-shaped structure that is disposed coaxially around the operator when the operator is at the initial position;

a conductor plate mounted coaxially on a bottom end of the operator such that the conductor plate is horizontally movable with the operator, and spaced vertically apart from the conductive patterns of the conductive layer, the conductor plate having a diameter larger than an inner diameter of the ring-shaped structure such that the conductor plate overlaps each of the conductive patterns when the operator is at the initial position;

a control unit connected electrically to the conductive patterns, the control unit being configured to provide a corresponding electrical signal to each of the conductive patterns to measure a capacitance generated between the conductor plate and each of the conductive patterns so as to generate a sensing output corresponding to the capacitances measured thereby, and to generate a pointer signal corresponding to the movement of the operator based on the sensing output and predetermined capacitance information.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view showing the first preferred embodiment of a pointing device according to the present invention;

FIG. 2 is a schematic top view illustrating the relationship between conductive patterns and a conductor plate of the first preferred embodiment when an operator is at an initial position;

FIG. 3 is a schematic circuit block diagram illustrating the first preferred embodiment;

FIG. 4 is a schematic sectional view showing the first preferred embodiment in a state of use;

FIG. 5 is schematic top view illustrating the relationship between the conductive patterns and the conductor plate when the first preferred embodiment is in the state of use;

FIG. 6 is a schematic sectional view showing the second preferred embodiment of a pointing device according to the present invention;

FIG. 7 is a schematic top view illustrating the relationship between conductive patterns and a conductor plate of the second preferred embodiment when an operator is at an initial position;

FIG. 8 is a schematic circuit block diagram illustrating the second preferred embodiment;

FIG. 9 is a schematic sectional view showing the second preferred embodiment in a state of use;

FIG. 10 is schematic top view illustrating the relationship between the conductive patterns and the conductor plate when the second preferred embodiment is in the state of use;

FIG. 11 is a schematic sectional view showing the third preferred embodiment of a pointing device according to the present invention;

FIG. 12 is a schematic top view illustrating the relationship between conductive patterns and a conductor plate of the third preferred embodiment when an operator is at an initial position;

FIG. 13 is a schematic circuit block diagram illustrating the third preferred embodiment;

FIG. 14 is a schematic sectional view showing the third preferred embodiment in a state of use; and

FIG. 15 is schematic top view illustrating the relationship between the conductive patterns and the conductor plate when the third preferred embodiment is in the state of use.

### DETAILED DESCRIPTION OF THE PREFERRED EMBODIMENTS

Before the present invention is described in greater detail, it should be noted that like elements are denoted by the same reference numerals throughout the disclosure.

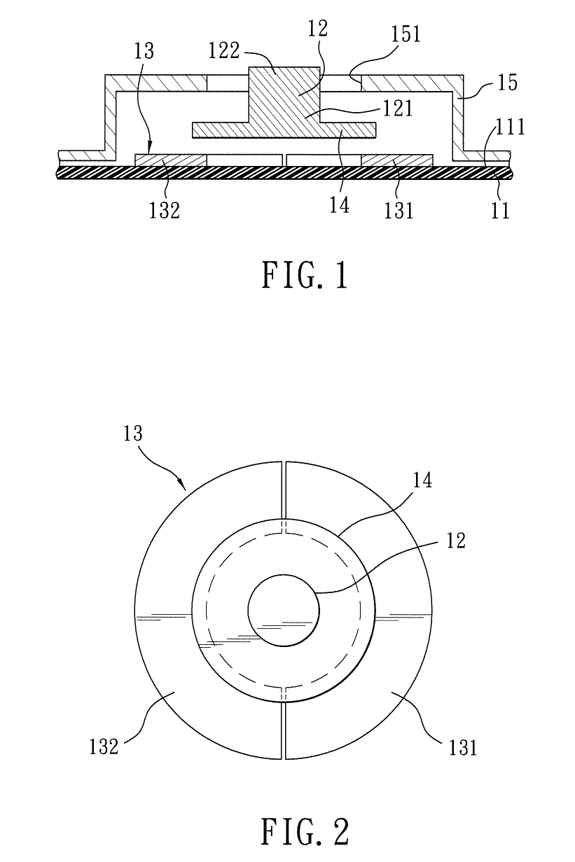

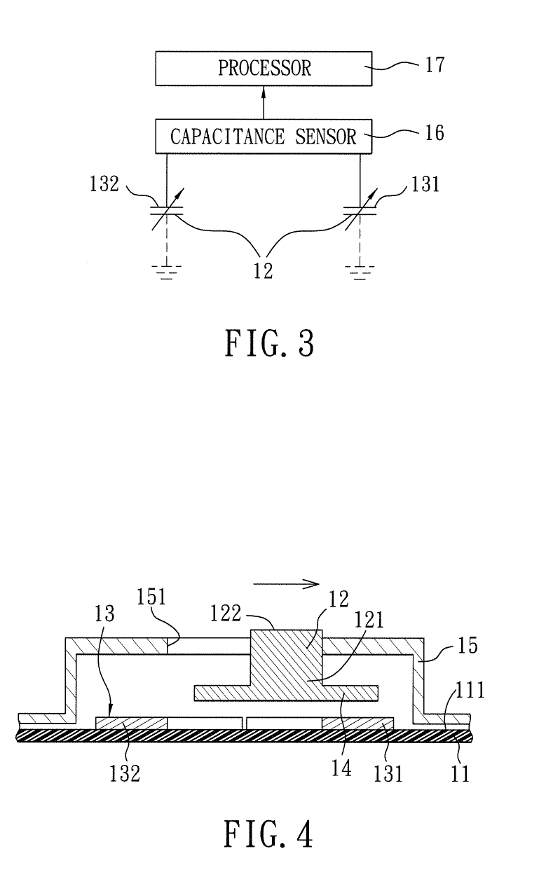

Referring to FIGS. 1 and 3, the first preferred embodiment of a pointing device according to the present invention is shown to include a substrate 11, an operator 12, a conductive layer 13, a conductor plate 14, a casing 15, a capacitance sensor 16, and a processor 17. The pointing device is adapted to be mounted to an electronic apparatus (not shown), such as a notebook computer, a mobile phone or a personal digital assistant, for generating, based on user's operation, a control input for the electronic apparatus to control movement of a cursor on a screen of the electronic apparatus.

In this embodiment, the substrate 11 is a circuit board and has a top surface 111.

The operator 12 is supported above the top surface 111 of the substrate 11 by a support frame (not shown) to be horizontally movable from an initial position. In this embodiment, the operator 12 is made of a conductive material, such as metal.

The conductive layer 13 is formed on the top surface 111 of the substrate. In this embodiment, the conductive layer 13 is in the form of a copper foil. Referring further to FIG. 2, the conductive layer 13 is formed with two half ring-shaped conductive patterns 131, 132 spaced apart from each other to form a ring-shaped structure that is disposed coaxially around the operator 12 when the operator 12 is at the initial position.

The conductor plate 14 is mounted coaxially on a bottom end 121 of the operator 12 such that the conductor plate 14 is horizontally movable with the operator 12. The conductor plate 14 is spaced vertically apart from the conductive patterns 131, 132. The conductor plate 14 has a diameter larger than an inner diameter of the ring-shaped structure such that the conductor plate 14 overlaps each of the conductive patterns 131, 132 when the operator 12 is at the initial position, as shown in FIG. 2. Since the conductor plate 14 moves with the operator 12, each of the conductive patterns 131, 132 has a changeable area overlapping the conductor plate 14. As a result, the conductive patterns 131, 132 cooperate with the conductor plate 14 to constitute two changeable capacitors (see FIG. 3). In this embodiment, the conductor plate 14 is connected integrally to the operator 12. As such, in use, the conductor plate 14 can be grounded through the operator 12 and through a user's finger touching the operator 12.

The casing 15 is mounted on the substrate 11 for covering the conductive patterns 131, 132 and the conductor plate 14. The casing 15 is formed with a central opening 151 permitting extension of an upper end 122 of the operator 12 therethrough (see FIG. 1).

The capacitance sensor 16 is connected electrically to the conductive patterns 131, 132, and provides a corresponding electrical signal to each of the conductive patterns 131, 132 during movement of the operator 12 to measure a capacitance generated between the conductor plate 14 and each of the conductive patterns 131, 132. The capacitance sensor 16 generates a sensing output corresponding to the capacitances measured thereby. In this embodiment, each electrical signal is a voltage signal. In other embodiments, each electrical signal can be a current signal or a frequency signal.

The processor 17 is connected electrically to the capacitance sensor 16 for receiving the sensing output from the capacitance sensor 16. The processor 17 is configured to generate, based on the sensing output and predetermined capacitance information, a pointer signal corresponding to the movement of the operator 12. The pointer signal serves as the control input for the electronic apparatus. The predetermined capacitance information includes at least reference capacitance that corresponds to the capacitance generated between the conductor plate 14 and each of the conductive patterns 131, 132 when the operator 12 is at the initial position. In this embodiment, the processor 17 cooperates with the capacitance sensor 16 to constitute a control unit.

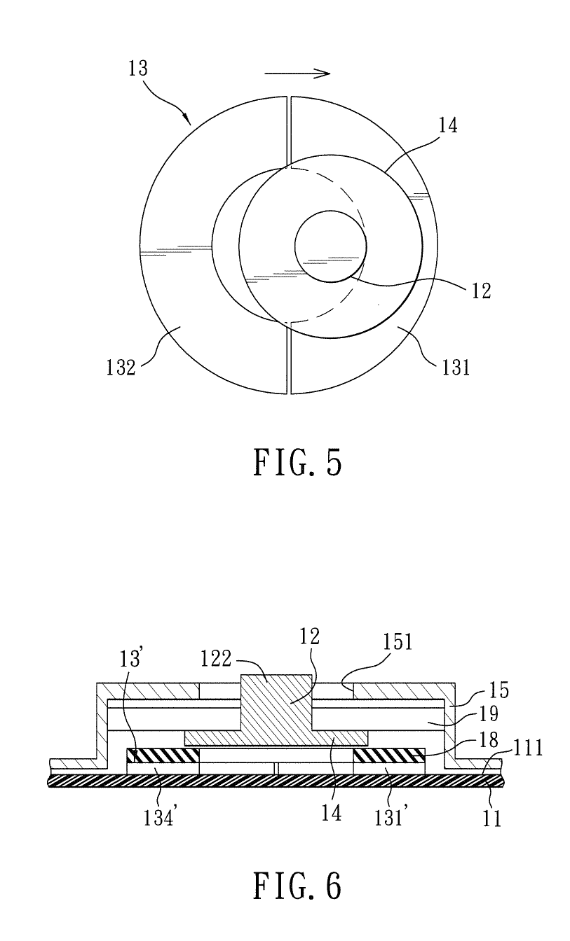

For example, as shown in FIGS. 4 and 5, when the operator 12 moves from the initial position toward the right in FIG. 4, the capacitance generated between the conductor plate 14 and the conductive pattern 131 increases and is larger than the reference capacitance, while the capacitance generated between the conductor plate 14 and the conductive pattern 132 reduces and is smaller than the reference capacitance. The processor 17 detects variance of the capacitance generated between the conductor plate 14 and each of the conductive patterns 131, 132 based on the sensing output from the capacitance sensor 16, and determines a pointer signal corresponding to such movement of the operator 12 based on a detection result.

FIGS. 6 to 8 illustrate the second preferred embodiment of a pointing device according to this invention, which is a modification of the first preferred embodiment.

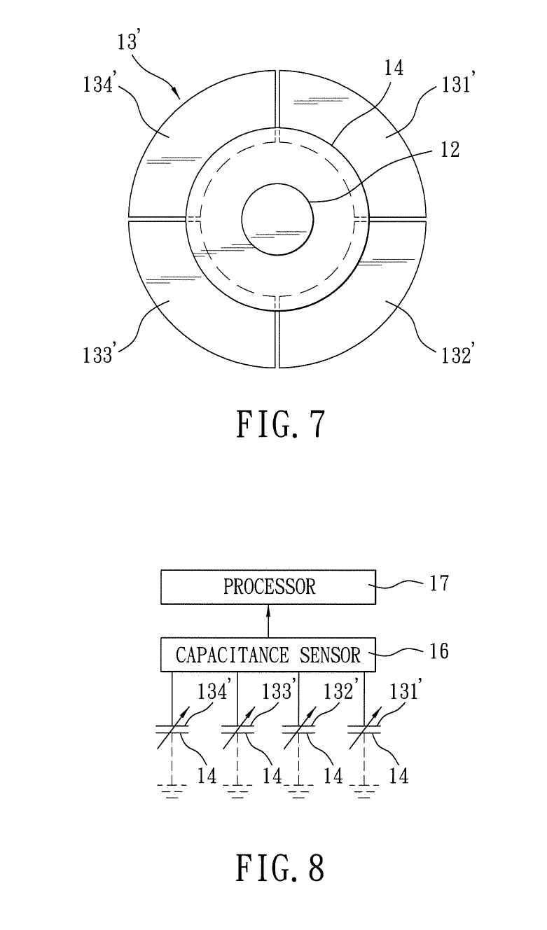

In this embodiment, the conductive layer 13′ is formed with four quarter ring-shaped conductive patterns 131′, 132′, 133′, 134′ spaced apart from each other to form the ring-shaped structure, as shown in FIG. 7. Thus, the conductive patterns 131′, 132′, 133′, 134′ cooperate with the conductor plate 14 to constitute four changeable capacitors (see FIG. 8).

In addition, the pointing device further includes an insulating layer 18, and a biasing member 19.

The insulating layer 18, such as a Mylar sheet, is formed on the conductive layer 13′ and is spaced apart from the conductor plate 14. In this embodiment, the insulating layer 18 is formed as a ring for isolating the conductive patterns 131′, 132′, 133′, 134′ from the conductor plate 14. In other embodiments, the insulating layer 18 can be made of an insulating material, such as Teflon, capable of enduring high temperature and having a low friction coefficient, and is coated over atop surface of the ring-shaped structure. In addition, Teflon can optionally be coated on a bottom surface of the conductor plate 14.

The biasing member 19 is sleeved on the operator 12, and is disposed fittingly in the casing 15 for biasing the operator 12 toward the initial position. In this embodiment, the biasing member 19 is made from ABS plastic.

The capacitance sensor 16 applies a corresponding voltage to each of the conductive patterns 131′, 132′, 133′, 134′ during movement of the operator 12 to measure a capacitance generated between the conductor plate 14 and each of the conductive patterns 131′, 132′, 133′, 134′. As such, the sensing output generated by the capacitance sensor 16 corresponds to the four capacitances of the changeable capacitors.

In this embodiment, the reference capacitance corresponds to the capacitance generated between the conductor plate 14 and each of the conductive patterns 131′, 132′, 133′, 134′ when the operator 12 is at the initial position.

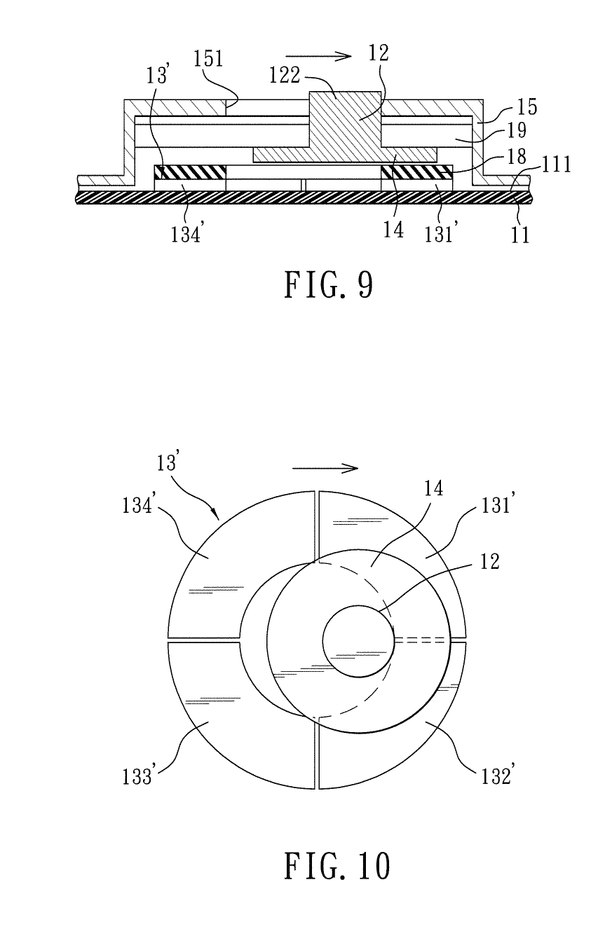

For example, as shown in FIGS. 9 and 10, when the operator 12 moves from the initial position toward the right in FIG. 9, the capacitance generated between the conductor plate 14 and each of the conductive patterns 131′, 132′ increases and is larger than a reference capacitance of the predetermined capacitance information while the capacitance generated between the conductor plate 14 and each of the conductive patterns 133′, 134′ reduces and is smaller than the reference capacitance. The processor 17 detects variance of the capacitance generated between the conductor plate 14 and each of the conductive patterns 131′, 132′, 133′, 134′ based on the sensing output from the capacitance sensor 16, and determines a pointer signal corresponding to such movement of the operator 12 based on a detection result.

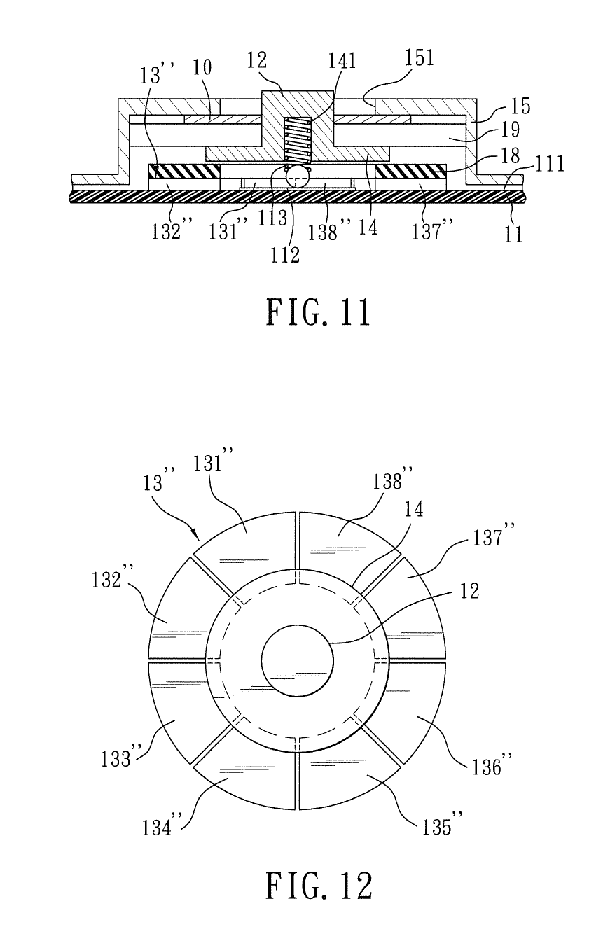

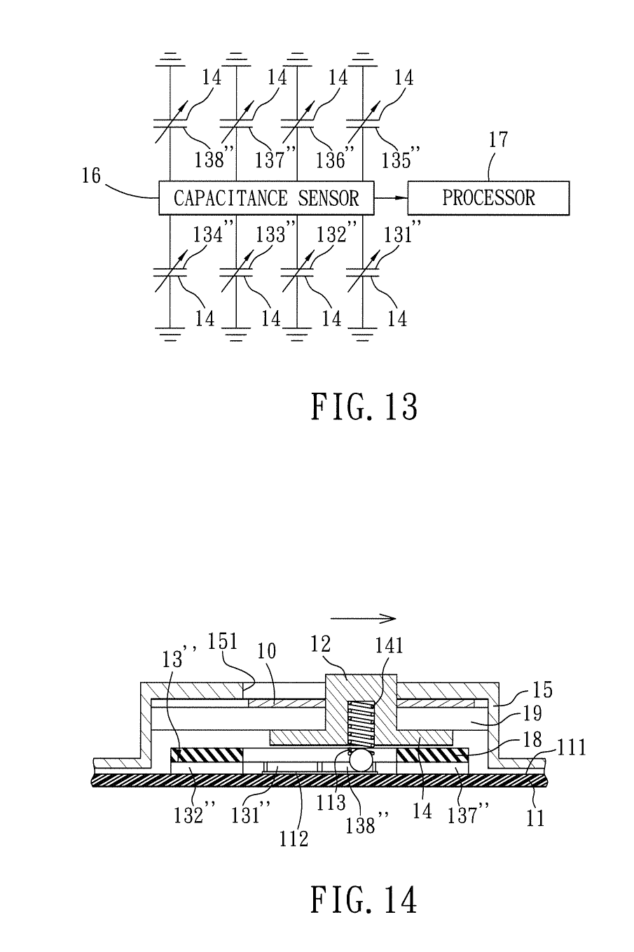

FIGS. 11 to 13 illustrate the third preferred embodiment of a pointing device according to this invention, which is a modification of the second preferred embodiment.

In this embodiment, the conductive layer 13″ is formed with eight arc ring-shaped conductive patterns 131″, 132″, 133″, 134″, 135″, 136″, 137″, 138″ spaced apart from each other to form the ring-shaped structure, as shown in FIG. 12. Thus, the conductive patterns 131″, 132″, 133″, 134″, 135″, 136″, 137″, 138″ cooperate with the conductor plate 14 to constitute eight changeable capacitors (see FIG. 8).

The substrate 11 is a circuit board, and includes a ground pad 112 and a conductive connecting member. The ground pad 112 is formed on the top surface 111 and is disposed at a center of the ring-shaped structure. In this embodiment, the conductive connecting member is a spring-loaded ball 113 for interconnects electrically the conductor plate 14 and the ground pad 112. The spring-loaded ball 113 has a spring end portion received in a spring receiving groove 141 in an assembly of the conductor plate 14 and the operator 12 and contacting electrically to the conductor plate 14, and a ball end portion contacting electrically and movably the ground pad 14. In other embodiments, the conductive connecting member 113 can be an electrical wire.

The pointing device further includes a metallic washer ring 10 sleeved on the operator 12 and disposed between the casing 15 and the biasing member 19

The capacitance sensor 16 applies a corresponding voltage to each of the conductive patterns 131″′, 132″, 133″, 134″, 135″, 136″, 137″, 138″ during movement of the operator 12 to measure a capacitance generated between the conductor plate 14 and each of the conductive patterns 131″, 132″, 133″, 134″, 135″, 136″, 137″, 138″. As such, the sensing output generated by the capacitance sensor 16 corresponds to the eight capacitances of the changeable capacitors.

In this embodiment, the reference capacitance corresponds to the capacitance generated between the conductor plate 14 and each of the conductive patterns 131″, 132″, 133″, 134″, 135″, 136″, 137″, 138″ when the operator 12 is at the initial position.

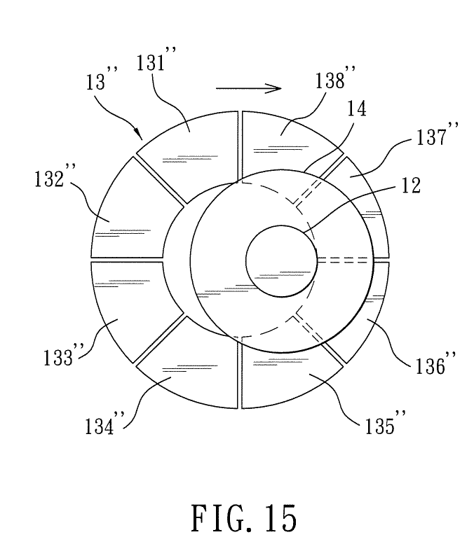

For example, as shown in FIGS. 14 and 15, when the operator 12 moves from the initial position toward the right in FIG. 14, the capacitance generated between the conductor plate 14 and each of the conductive patterns 136″, 137″ increases and is larger than the reference capacitance while the capacitance generated between the conductor plate 14 and each of the conductive patterns 132″, 133″ reduces to be smaller than a reference capacitance value (i.e., when the conductor plate 14 does not overlap the conductive patterns 132″, 133″). The processor 17 detects variance of the capacitance generated between the conductor plate 14 and each of the conductive patterns 131″, 132″, 133″, 134″, 135″, 136″, 137″, 138″ based on the sensing output from the capacitance sensor 16, and determines a pointer signal corresponding to movement of the operator 12 based on a detection result.

In sum, the conductive layer 13, 13′, 13″, the conductor plate 14 and the capacitance sensor 16 constitute a capacitive sending device for sensing capacitances between the conductor plate 14 and the conductive layer 13, 13′, 13″. Therefore, the pointing device of this invention has a relatively simple structure and can be easily fabricated at low cost as compared to the prior art. In addition, the pointing device has a small height. Thus, the pointing device is suitable for an electronic apparatus with a compact size.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A capacitive sensing device for sensing horizontal movement of an operator of a pointing device relative to an initial position, said capacitive sensing device comprising:
a substrate adapted to be disposed under the operator and having a top surface;
a conductive layer formed on said top surface of said substrate, and formed with a plurality of conductive patterns spaced apart from each other and configured to form a ring-shaped structure that is disposed coaxially around the operator when the operator is at the initial position;
a conductor plate adapted to be mounted coaxially on a bottom end of the operator such that said conductor plate is horizontally movable with the operator, and spaced vertically apart from said conductive patterns of said conductive layer, said conductor plate having a diameter larger than an inner diameter of the ring-shaped structure such that said conductor plate overlaps each of said conductive patterns when the operator is at the initial position; and
a capacitance sensor connected electrically to said conductive patterns, and providing a corresponding electrical signal to each of said conductive patterns during the movement of the operator to measure a capacitance generated between said conductor plate and each of said conductive patterns, the capacitances measured by said capacitance sensor being associated with the movement of the operator.

2. The capacitive sensing device as claimed in claim 1, further comprising an insulating layer formed on said conductive layer and spaced apart from said conductor plate.

3. The capacitive sensing device as claimed in claim 1, further comprising a casing mounted on said substrate for covering said conductive patterns and said conductor plate;
wherein said casing is formed with a central opening adapted for permitting extension of an upper end of the operator therethrough.

4. The capacitive sensing device as claimed in claim 3, further comprising a biasing member adapted to sleeved on the operator and disposed fittingly in said casing for biasing the operator toward the initial position.

5. The capacitive sensing device as claimed in claim 4, further comprising a washer ring adapted to be sleeved on the operator and disposed between said casing and said biasing member.

6. The capacitive sensing device as claimed in claim 1, the operator being made of a conductive material, wherein said conductor plate is adapted to be connected integrally to the operator.

7. The capacitive sensing device as claimed in claim 1, wherein said substrate is a circuit board, and includes:
a ground pad formed on said top surface and disposed at a center of the ring-shaped structure; and
a conductive connecting member interconnecting electrically said conductor plate and said ground pad.

8. The capacitive sensing device as claimed in claim 7, wherein said conductive connecting member is a spring-loaded ball.

9. The capacitor sensing device as claimed in claim 1, wherein each of the electrical signals provided by said capacitance sensor is one of a voltage signal, a current signal and a frequency signal.

10. A pointing device comprising:
a substrate having a top surface;
an operator supported above said top surface of said substrate to be horizontally movable from an initial position;
a conductive layer formed on said top surface of said substrate, and formed with a plurality of conductive patterns spaced apart from each other and configured to form a ring-shaped structure that is disposed coaxially around the operator when the operator is at the initial position;
a conductor plate mounted coaxially on a bottom end of said operator such that said conductor plate is horizontally movable with said operator, and spaced vertically apart from said conductive patterns of said conductive layer, said conductor plate having a diameter larger than an inner diameter of the ring-shaped structure such that said conductor plate overlaps each of said conductive patterns when said operator is at the initial position;
a control unit connected electrically to said conductive patterns, said control unit being configured to provide a corresponding electrical signal to each of said conductive patterns during movement of said operator to measure a capacitance generated between said conductor plate and each of said conductive patterns so as to generate a sensing output corresponding to the capacitances measured thereby, and to generate a pointer signal corresponding to the movement of said operator based on the sensing output and predetermined capacitance information.

11. The pointing device as claimed in claim 10, further comprising an insulating layer formed on said conductive layer and spaced apart from said conductor plate.

12. The pointing device as claimed in claim 10, further comprising a casing mounted on said substrate for covering said conductive patterns and said conductor plate, said casing being formed with a central opening permitting extension of an upper end of said operator therethrough.

13. The pointing device as claimed in claim 12, further comprising a biasing member sleeved on said operator and disposed fittingly in said casing for biasing said operator toward the initial position.

14. The pointing device as claimed in claim 13, further comprising a washer ring sleeved on said operator and disposed between said casing and said biasing member.

15. The pointing device as claimed in claim 10, wherein said operator is made of a conductive material and is connected integrally to said conductor plate.

16. The pointing device as claimed in claim 10, wherein said substrate is a circuit board, and includes:
a ground pad formed on said top surface and disposed at a center of the ring-shaped structure; and
a conductive connecting member interconnecting electrically said conductor plate and said ground pad.

17. The pointing device as claimed in claim 16, wherein:
an assembly of said operator and said conductor plate is formed with a spring-receiving groove; and
said conductive connecting member is a spring-loaded ball received partially in said spring-receiving groove and contacting electrically said conductor plate.

18. The pointing device as claimed in claim 10, wherein said control unit includes:
a capacitance sensor connected electrically to said conductive patterns, providing the corresponding electrical signal to each of said conductive patterns during movement of said operator to measure the capacitance generated between said conductor plate and each of said conductive patterns, and generating the sensing output corresponding to the capacitances measured thereby; and
a processor connected electrically to said capacitance sensor for receiving the sensing output from said capacitance sensor, said processor being configured to generate the pointer signal corresponding to the movement of said operator based on the sensing output and predetermined capacitance information.

19. The pointing device as claimed in claim 18, wherein each of the electrical signals provided by said capacitance sensor is one of a voltage signal, a current signal and a frequency signal.
